(19) United States
(12) Patent Application Publication
(10) Pub. No.: US 2025/0049069 A1
(43) Pub. Date: Feb. 13, 2025

(54) Oil Seed Protein Isolate and Process for Production

(71) Applicant: Louis Dreyfus Company Plant Proteins LLC, Livermore, CA (US)

(72) Inventors: Manoj Kumar, Livermore, CA (US); Prasanth Kumar Sasidharan Pillai, Livermore, CA (US)

(73) Assignee: Louis Dreyfus Company Plant Proteins LLC, Livermore, CA (US)

(21) Appl. No.: 18/792,418

(22) Filed: Aug. 1, 2024

Related U.S. Application Data
(60) Provisional application No. 63/532,306, filed on Aug. 11, 2023.

(51) Int. Cl. A23J 1/14; A23D 7/005; A23J 3/14

(52) U.S. Cl. CPC A23J 1/14; A23D 7/0053; A23J 3/14

(57) ABSTRACT

Provided herein are oil seed protein isolates with novel properties, processes for producing oil seed protein isolates, and uses for oil seed protein isolates.

### CROSS-REFERENCE

This application claims benefit of U.S. Provisional Patent Application No. 63/532,306 filed Aug. 11, 2023, which application is incorporated herein by reference in its entirety.

### BACKGROUND OF THE INVENTION

Oil seeds, such as rapeseed/canola and sunflower seeds, are an emerging a source of proteins for culinary applications. Recent trends toward the use of vegetable proteins to replace animal-derived protein has created a significant demand for the production of plant protein products with unique and desirable qualities, particularly for use in foods meant to replace animal-based products. Seed-derived proteins have become a coveted source for producing nutritionally-enhanced products and meat and dairy substitutes with preferred textural appeal and varied functionalities. Therefore, protein isolates from seeds that are both economical and have desirable physical properties for use in plant-based foods and products is needed.

The production of protein isolates from oil seeds has been actively pursued for several decades. U.S. Pat. No. 6,992,173 describes production of canola seed protein isolate from cold-pressed canola flour through a selective membrane technique and controlling ionic strength, as does U.S. Pat. No. 7,687,087. Various other procedure involving selective membrane techniques and/or diafiltration are described in U.S. Pat. Nos. 8,580,330, 9,115,202, 11,013,243 and U.S. published application No. 20212-20269948A1. Other disclosures employ heat to provide canola protein isolates, including U.S. Pat. Nos. 7,955,625, 7,959,968, 8,021,703 and 8,999,426. U.S. Pat. No. 8,728,542 describes production of sunflower seed protein preparations involving pressing, supercritical CO2 and/or superheated hexane. Various Other disclosures employ heat to provide sunflower protein concentrates, such as U.S. Pat. No. 10,645,950. Other procedures involving selective membrane techniques and/or diafiltration are described in U.S. published application No. 2022-0053791A1. Production of novel oil seed protein compositions with unique functionality by procedures that are technologically and economically viable are in constant demand.

### SUMMARY OF THE INVENTION

The present invention provides a process for producing an oil seed protein isolate from de-oiled oil seed flour that is economical and produces oil seed protein isolate that has unique composition and functionality. The process involves use of low temperatures below where denaturation of proteins occurs to produce an oil seed protein product with a protein content 80-98 wt % (N×6.25) on a dry basis and ≤3% oil while substantially maintaining the native form of the proteins in the flour. The oil seed protein isolates of the invention have highly desirable foaming, gelation and emulsion attributes, making them applicable to many plant-based food and beverage applications.

In one aspect of the invention, a process is provided for extracting an oil seed protein isolate comprising, stepwise, separating hulls, if present, from desolvented, de-oiled oil seed flour, alkaline hydration of the hull-free, desolvented, de-oiled seed flour with an aqueous solution at pH 7-11 and a temperature of 5-62° C., optionally including Na, Mg or Ca salt, separating the solids from the solution to produce a liquid fraction, precipitating and separating the protein from the liquid fraction at pH 3-7.5 and a temperature of 5-62° C., diluting the protein to produce a protein slurry, homogenizing, sterilizing and/or pasteurizing and drying the protein slurry. In certain embodiments, the de-oiled, desolvented oil seed flour contains ≤3% oil. In certain embodiments, the alkaline hydration step is at pH 7.5-10. In some embodiments, the alkaline hydration step is at 18-60° C. In certain embodiments, each salt is independently selected from NaCl, CaCl, MgCl, Sodium hexametaphosphate, calcium perchlorate, sodium sulfite, sodium bisulfite, sodium thiocyanate and calcium thiocyanate. In some embodiments, the salt concentration in step b. is 0.1-5%. In certain embodiments, the solids concentration in the alkaline hydration step is 10-20%. In some embodiments, the alkaline hydration step is performed for 30-60 minutes. In certain embodiments, the separation of solids to produce a liquid fraction is done by decantation and/or centrifugation. In some embodiments, the protein precipitation and separation step is performed at pH 4-7. In some embodiments, the precipitation of step d. is performed at pH 4-6. In certain embodiments, the protein precipitation and separation step is performed at 18-60° C. In a specific embodiment, the dilution step is with water and adjusted to about pH 7. In certain embodiments of the process, the oil seed is selected from rapeseed (including canola), sunflower seed, mustard seed, cotton seed, peanut, sesame, safflower, soybean, flax seed, tree nuts, palm kernel and corn. In some embodiments, the oil seed is canola. In other embodiments, the oil seed is sunflower seed.

In another aspect of the invention, an oil seed protein isolate produced by the above process is provided. In certain embodiments, the oil seed protein isolate has a protein content of 80-98% by weight (N×6.25) on a dry basis. In some embodiments, the protein is substantially maintained in its native form. In some embodiments, the oil seed protein isolate is capable of forming a gel in water. In some embodiments, the oil seed protein isolate has foaming capacity. In certain embodiments, the oil seed protein isolate is capable of forming an emulsion in a mixture of equal parts oil and water.

In specific aspects of the invention, the oil seed is canola. In certain embodiments, the canola protein isolate comprises oleosin. In certain embodiments, the canola protein isolate comprises 10-20% oleosin. In some embodiments, the canola protein isolate comprises 50-65% cruciferin, 5-20% oleosin and 8-15% napin. In certain embodiments, the canola protein isolate is capable of gelling at a concentration of 0.5% or greater. In some embodiments, the canola protein isolate is capable of gelling at a concentration of 0.5-5%. In certain embodiments, the canola protein isolate has a foaming capacity of ≥100% at a concentration of 0.5-5% (w/w). In some embodiments, the canola protein isolate has a foaming capacity of 180-300% at a concentration of 5% by weight. In certain embodiments, the canola protein isolate has a foaming stability of 50-95% for ≥100 minutes at a concentration of 0.4-5% by weight. In some embodiments, the canola seed protein isolate has a foaming stability of 50-95% for at least 200 minutes at a concentration of 5% by weight. In certain embodiments, the canola protein isolate has oil/water emulsion stability of 100% for at least 24 hours at a concentration ≥0.5% in a mixture of equal parts oil and water. In some embodiments, the canola protein isolate has oil/water emulsion stability of 100% for at least 48 hours at a concentration ≥0.5%. In some embodiments, the canola protein isolate has oil/water emulsion stability of 100% for at least 48 hours at a protein concentration 0.5-5%.

In different specific aspects of the invention the oil seed protein isolate is of sunflower seed. In some embodiments, the sunflower protein isolate comprises a protein component that is 80 wt % (N×6.25) to 93 wt % on a dry basis. In certain embodiments, the sunflower protein isolate protein component comprises 50-90% helianthin proteins and 10-40% albumin and oleosin proteins. In some embodiments, the sunflower protein isolate is capable of gelling in water at a concentration of 5% by weight. In some embodiments, the sunflower protein isolate has a foaming capacity ion water of 180-300% at a concentration of 5% by weight. In some embodiments, the sunflower protein isolate has foaming stability of 50-80 in water at a concentration of 5% by weight for a period of at least 60 minutes. In some embodiments, the sunflower protein isolate has emulsion stability in a mixture of equal parts water and oil of 100% for at least 24 hours at a concentration of 0.505% by weight.

In yet another aspect of the invention, a canola seed protein isolate comprising oleosin is provided. In certain embodiments, the canola seed protein isolate protein component comprises 5-20% oleosin. In some embodiments, the canola seed protein isolate protein component comprises 12-15% oleosin. In some embodiments, the canola seed protein isolate protein component comprises 50-65% cruciferin, 10-20% oleosin and 8-15% napin. In some embodiments, the canola seed protein isolate comprises 1-3% fat, ≥1.5% phytates, 5-8% carbohydrates, 4-6% ash, ≥0.5% polyphenol and ≤0.1% glucosinolates. In certain embodiments, the canola seed protein isolate is capable of gelling at a concentration of ≥3% in water. In some embodiments, the canola seed protein isolate is capable of gelling at a concentration of 3-5% in water. In certain embodiments, the canola seed protein isolate has foam expansion capacity of ≥100% in water at a concentration of 0.5-5% by weight. In some embodiments, the canola seed protein isolate has foam expansion capacity of 180-300% in water at a concentration of 5% by weight. In certain embodiments, the canola seed protein isolate has foaming stability of 50-95% at a concentration of 0.5-5% by weight in water for ≥100 minutes. In some embodiments, the canola seed protein isolate has foaming stability of 50-95% at a concentration of 5% by weight in water for at least 200 minutes. In certain embodiments, the canola seed protein isolate has oil/water (1:1) stability of 100% at a concentration of ≥0.5% in water for ≥24 hours. In some embodiments, the canola seed protein isolate has oil/water (50/50) stability of 100% at a concentration of ≥0.5% by weight ≥48 hours. In yet other embodiments, the canola seed protein isolate has oil/water (50/50) emulsion stability of 100% at a concentration of 0.5-5% by weight for ≥48 hours. In certain embodiments, the protein in the canola seed protein isolate is substantially in its native form.

In a different aspect of the invention, use of the oil seed protein isolate described above in the production of a foam is provided. In another aspect of the invention, use of the oil seed protein isolate described above in the production of a gel is provided. In yet another aspect of the invention, use of the oil seed protein isolate described above in the production of an emulsion is provided. In some embodiments, the emulsion is in a mixture of equal parts water and oil.

In a different aspect of the invention, a foam comprising the oil seed protein isolates described above is provided. In certain embodiments, the foam comprises ≥5% oil seed protein isolate by weight. In other embodiments, the foam comprises ≥0.5% oil seed protein isolate by weight. In other embodiments, the foam comprises 0.5-5% oil seed protein isolate by weight.

In another aspect of the invention, a gel comprising the oil seed protein isolates described above is provided. In certain embodiments, the gel comprises 3% oil seed protein isolate. In other embodiments, the gel comprises ≥3% oil seed protein isolate. In other embodiments, the gel comprises 3-5% oil seed protein isolate.

In yet another embodiment, an emulsion comprising the oil seed protein isolates described above is provided. In certain embodiments, the emulsion comprises 0.5% oil seed protein isolate. In other embodiments, the emulsion comprises ≥0.5% oil seed protein isolate. In other embodiments, the emulsion comprises 0.5-5% oil seed protein isolate.

In a different aspect of the invention, use of the oil seed protein isolates described above in a food or beverage application is provided. In some embodiments, the food or beverage application is selected from milk shake, protein bars, meat analogues, confectionary, condiments, mayonnaise, salad dressing, nutritional supplements and dairy alternatives. In certain embodiments, the dairy alternative is selected from creamers, ice cream, buttermilk, yogurt and cheese.

In a different aspect of the invention, a food or beverage comprising the oil seed protein isolates described above is provided.

### BRIEF DESCRIPTION OF THE DRAWINGS

FIGS. 1A-C shows canola seeds, flaked canola seed flour and de-oil, desolvented flaked canola seed flour, respectively.

FIG. 2A shows the hexane with extracted oil after each of 6 rounds of extraction of canola seed oil from flakes canola seed flour.

FIG. 2B shows the Brix refractive index (Brix RI) for hexane (at point 0) and for each of the 6 extraction cycles in the canola seed oil extraction process described in Example 1.

FIG. 3A-D shows canola protein isolate produced using the canola seed protein extraction process described herein.

FIG. 4 shows differential scanning calorimetry of deoiled canola seed flakes.

FIG. 5 shows canola protein isolate produced by the methods herein.

FIG. 6 shows differential scanning calorimetry performed on the CPI produced using the canola seed protein isolate extraction process disclosed herein.

FIG. 7 shows and SDS-PAGE analysis of CPI, showing the presence of cruciferin, oleosin and napin.

FIG. 8A-B shows samples of gels produced using the CPI of the invention.

FIGS. 9A-C show sunflower seeds, dehulled, milled ground sunflower seed flour and de-oil, desolvented sunflower seed flour, respectively.

FIG. 10 shows hexane with extracted oil after each of 4 rounds of extraction of sunflower seed oil from ground sunflower seed flour.

FIG. 11 shows differential scanning calorimetry performed on the SFPC produced using the sunflower protein concentrate extraction process disclosed herein.

FIG. 12A-B show foam expansion of SFPI after foaming and foam stability 1 hour after foaming, respectively, as described in Example 12.

FIG. 13 shows a sample of an emulsion of SFPI as described in Example 13.

### DETAILED DESCRIPTION OF THE INVENTION

Processes are provided for the extraction of a protein isolate from de-oil, desolvented oil seed flour, as well as oil seed isolate compositions, compositions comprising oil seed protein isolates and uses for such oil seed protein isolates. The processes involve the extraction of oil seed protein isolate from de-oiled, desolvented oil seed flour at low temperatures and not requiring membrane filtration-based separation. The coil seed protein isolate amenable to further uses in the form of foams, gels and emulsions and in various food and beverage applications. Detailed examples of canola protein isolates and sunflower protein isolates are also provided.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “about”, particularly in reference to a given quantity, is meant to encompass deviations of plus or minus five percent.

“Extracting” or “extraction” means the removal or separation of one or more component(s) of a multicomponent composition. The concept of extracting a protein isolate from a seed protein flour is well known in the present art.

“de-oiled oil seed flour” means oil seed flour from which 97-99% of the oil has been removed through an oil extraction process. Such a process is described in a concurrently filed patent application.

“Desolventing” means the removal of residual solvent, such as hexane, from de-oiled seed flour. “Desolvented” means something that has gone through desolventing.

“Substantially in native form” in the context of proteins in in oil seed flour means that the proteins have not been denatured due to, for example, exposure to excessive heat, such that the 3-dimensional structure of the proteins are generally maintained in the form found in the pre-processed seed.

Extracting Oil Seed Protein Isolate from Oil Seed Flour

Processes are provided for the production of canola seed protein isolates from de-oil, desolvented canola flour. A process for de-oiling and desolventing is disclosed in concurrently filed U.S. patent application Ser. No. 18/792,381, incorporated herein by this reference. A brief description of the de-oiling and desolventing process is described in Example 1 herein. Other means of providing de-oiled desolvented oil seed flour are known in the art.

De-oiled, desolvented oil seed flour may first have the fraction containing hulls, if any, removed to provide a relatively fine powder, substantially free of seed hulls. This may be done by any of a number of means known in the art. Examples of methods for removing hulls include sieving, air classification, or a combination of these.

The de-oiled, desolvented, hull-free oil seed flour is then subjected to alkaline hydration by placing the oil seed flour in an aqueous solution at a range of pH 7 to pH 11 at a temperature of about 5-62° C. In some embodiments the pH range of the alkaline hydration mixture is narrower, such as pH 7.5 to pH 10. In some embodiments, the temperature range is narrower, in the range of about 18-60° C. It is important to keep the temperature below that which causes denaturation of proteins in the canola flour. Therefore, use of temperatures exceeding about 60° C. for any significant amount of time is contrary to the current invention. Generally, temperature is kept at or below about 60° C. throughout the canola protein isolate extraction process, except where specifically required, such as for a brief period for sterilization and/or pasteurization, as further discussed below. The alkaline hydration mixture is typically 10-20% solids, determination of a functional concentration of solids is well within the scope of what is known in the art. Likewise, the time of alkaline hydration may be readily set based on the current knowledge of the skilled artisan. Typically, alkaline hydration is performed for 30-60 minutes.

The alkaline hydration solution can also include one or more types of salt. Optional salts that can be used in the alkaline hydration solution include Na, Mg, Ca, NaCl, MgCl, sodium hexametaphosphate, calcium perchlorate, sodium sulfite, sodium bisulfite, sodium sulfide, sodium thiocyanate, calcium thiocyanate or a combination of these. Other cationic salts, including K, may also be used, however, consideration should be given to relative toxicity, as the oil seed protein isolate is ultimately intended for human consumption. Addition of salts to alkaline hydration is a known process and the skilled artisan can readily determine an acceptable salt. The optional salt(s) are typically at a total concentration of 0.1-5%. A determination of a useful salt and its concentration is also well within the knowledge of a skilled artisan.

The solids of the alkaline hydration mixture are then separated from the aqueous component, producing a liquid fraction for further processing. Means for separating solids from an alkaline hydration solution are well known in the art. A common method of separation is centrifugation. Another method is decanting. Any method or combination of methods of separation may be employed, and the determination of a proper method of separating a liquid fraction from the solids is well within the skill of the ordinary artisan. The solids may be subsequently washed with additional alkaline hydration solution; wash times may be similar to the initial hydration process and liquid from these washes are also collected.

Protein in the liquid fraction is then precipitated out. This is generally done by lowering the pH or meeting the isoelectric point of the liquid fraction. Precipitation of protein from a liquid fraction is a known process. The pH of the liquid is reduced to 4-7, which may be done stepwise, first to pH 6-7, then to pH 4-5. The precipitation step is carried out at a temperature of 4-60° C. As stated above, it is important to keep the temperature of the extraction process at or below about 60° C. The precipitation time can range from 5 to 60 minutes.

The precipitated protein is then separated from the liquid by standard means, such as decanting and/or centrifugation. The protein may get subsequent washes with water at precipitation pH (e.g., pH 4-5). The separated protein is then diluted with water adjusted to about pH 7, creating a protein slurry. The protein slurry is homogenized by means known in the art. For example, a high pressure homogenizer may be used. The homogenized protein slurry is then sterilized and/or pasteurized. This is the only time at which the extracted protein is subjected to temperatures above about 60° C. Means for sterilizing protein for use in foods are known in the art. An example of such a means is direct steam injection. The protein slurry may be subjected to direct steam injection for between 2 seconds and 10 minutes.

The protein slurry is then dried using a drying apparatus known in the art, provided that heat above about 60° C. is not used. Several such apparatuses, such as spray dryers, ring dryers, dispersion dryers, drum dryers and fluid bed dryers, are commercially available. The resulting canola seed protein isolate may then be used as further described below.

### Oil Seed Protein Isolates

In addition to the production of oil seed protein isolate, the present invention provides oil seed protein isolates provided by such process and oil seed protein isolates having particular useful characteristics. The oil seed protein isolate produced by the above process has protein content of 80-98% by weight (wt %) on a dry basis, calculated using the Kjeldahl method (N×6.25). The process allows for the protein in the oil seed protein isolate to substantially maintain its native form.

In certain embodiments, and as a specific example of the products of the invention, canola seed protein isolates, also referred to herein as canola protein isolates (CPI), are provided. In addition to the expected components of cruciferin and napin, as is found in other described canola protein isolates, the protein of the present CPI contains oleosin as well. The oleosin makes up 5-20% of the protein in the CPI. In some embodiments, the oleosin content ranges from 12-15% of the protein. The protein component of the CPI produced using the present protein isolate extraction process contains 50-65% cruciferin and 8-20% napin. In addition, the CPI typically contains ≤1-3% fat (including oil), ≥1.5% phytates, 5-8% carbohydrates, 4-6% ash, ≤0.5% polyphenol and ≤0.1% glucosinolates.

In other embodiments, and provided as another specific example of the products of the invention, sunflower seed protein isolates, also referred to herein as sunflower protein isolates (SFPI), are provided. In certain embodiments, the SFPI of the present invention have a protein component that is 80 wt % to 93 wt % on a dry basis. In some embodiments, the SFPI protein component comprises 50-=90% helianthin proteins and 10-40% albumin and oleosin proteins. In some embodiments, the SFPI further comprises 1-3% fat, 0.5-2% phytates, 5-8% carbohydrates, 4-6% ash, ≤0.5% polyphenol and ≤0.1% chlorogenic acid.

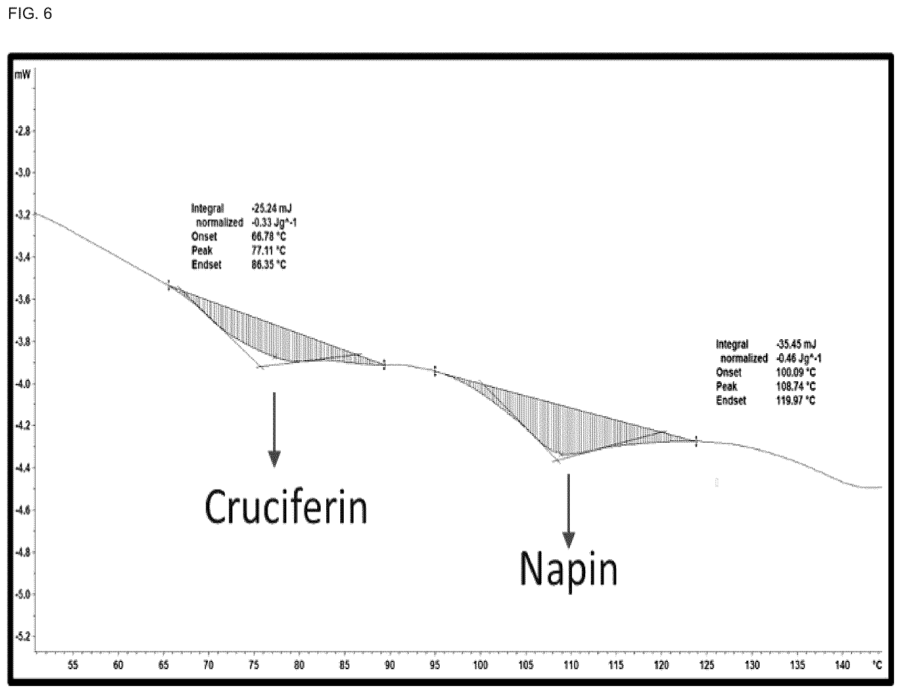

The oil seed protein isolates of the present invention have several attributes that make them especially useful in the plant-based food and beverage industry. For example, the oil seed protein isolates are capable of gelling in water, typically at a concentration of ≥0.5-5%. FIG. 6 shows examples of gelled CPI in water at a concentration of 3-5%, where the gelling was produced by heating to 95° C. followed by cooling to 5° C. Similarly, SFPI produced using the process of the invention shows excellent gelling capacity at a concentration of 5%.

Additionally, the oil seed protein isolates of the present invention have foaming capacity, typically at a concentration of ≥0.5% in water. For example, CPI of the invention has foam expansion capacity of ≥100% at concentrations of 0.5-5% in water. The foaming expansion capacity of 5% CPI in water ranges from 180-300%. In addition, the CPI at a concentration of 5% in water has foaming stability of 50-95% for ≥100 minutes; in some embodiments the 50-95% foaming stability is greater than 200 minutes. As another example, SFPI of the invention has foam expansion capacity of 180-300% at a concentration of 5% by weight and foaming stability of 50-80% for a period ≥200 minutes. FIG. X shows an example of 180-300% foaming expansion of 5% CPI in water.

The CPI also has the capacity to form an emulsion in a 1:1 mixture of water and oil at CPI concentration of ≥0.5%. At CPI concentrations of 0.5-5% in a water and oil 1:1 mixture, emulsions maintained 100% stability for greater than 24 hours; in some embodiments 100% stability was maintained for greater than 48 hours. FIG. X shows emulsion of 5% (w/w) CPI in equal parts water and oil, produced with a homogenizer run at 8000 rpm for 3 minutes.

The gelling, foaming and emulsification attribute of the CPI of the present invention provide for various plant-based food applications, as further described below.

### Uses of Oil Seed Protein Isolates

The canola seed protein isolates have a variety of uses, particularly in plant-based food and beverage applications. The CPI of the present invention finds use in, for example, milk shakes, protein bars, meat analogues, confectionary, condiments, mayonnaise, salad dressing, nutritional supplements and dairy alternatives such as creamer, ice cream, yogurt and cheese.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-78 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:

1. An oil seed protein isolate extraction process comprising, step-wise:
a. separating hulls, if present, from desolvented, de-oiled oil seed flour,
b. alkaline hydration of hull-free, desolvented, de-oiled oil seed flour with an aqueous solution:
   i) at a pH of 7-11,
   ii) at a temperature of 5-62° C.,
   iii) optionally including Na and/or Ca and/or Mg salt,
c. separation of solids from the solution, producing a liquid fraction,
d. precipitation and separation of protein from liquid fraction:
   i) at pH 3-7.5
   ii) at a temperature of 5-62° C.,
e. dilution of the protein to produce a slurry,
f. homogenization and sterilization of protein slurry
g. drying protein slurry.

2. The process of Aspect 1, wherein the de-oiled, desolvented oil seed flour contains ≤3% oil.

3. The process of any of Aspects 1-2, wherein the pH in step a. is 7.5-10.

4. The process of any of Aspects 1-3, wherein the temperature in step b. is 18-60° C.

5. The process of any of Aspects 1-4, wherein each salt is independently selected from NaCl, CaCl, MgCl, Sodium hexametaphosphate, calcium perchlorate, sodium sulfite, sodium bisulfite, sodium thiocyanate and calcium thiocyanate.

6. The process of any of Aspects 1-5, wherein the salt concentration in step b. is 0.1-5%.

7. The process of any of Aspects 1-6, wherein the solids concentration in step b. is 10-20%.

8. The process of any of Aspects 1-7, wherein the alkaline hydration step b. is carried out for 30-60 minutes.

9. The process of any of Aspects 1-8, wherein separation step c. is by decantation and/or centrifugation.

10. The process of any of Aspects 1-9, wherein precipitation of step d. is performed at pH 4-7.

11. The process of any of Aspects 1-10, wherein precipitation of step d. is performed at pH 4-6.

12. The process of any of Aspects 1-11, wherein the temperature in step d, is 18-60° C.

13. The process of any of Aspects 1-12, wherein the dilution step is with water and adjusted to about pH 7.

14. The process of any of Aspects 1-13, wherein the oil seed is selected from the group comprising: rapeseed (including canola), sunflower seed, mustard seed, cotton seed, peanut, sesame, safflower, soybean, flax seed, tree nuts, palm kernel and corn.

15. The process of any of Aspects 1-14, wherein the oil seed is canola.

16. The process of any of Aspects 1-14, wherein the oil seed is sunflower.

17. An oil seed protein isolate made by the process of any of Aspects 1-16.

18. The oil seed protein isolate of Aspect 17, wherein the protein content is 80-98 wt % (N×6.25) d.b.

19. The oil seed protein isolate of any of Aspects 17-18, wherein the protein is substantially maintained in its native form.

20. The oil seed protein isolate of any of Aspects 17-19, wherein the oil seed is selected from the group comprising: rapeseed (including canola), sunflower seed, mustard seed, cotton seed, peanut, sesame, safflower, soybean, flax seed, tree nuts, palm kernel and corn.

21. The oil seed protein isolate of any of Aspects 17-20 capable of forming a gel in water.

22. The oil seed protein isolate of any of Aspects 17-21 having foaming capacity in water.

23. The oil seed protein isolate of any of Aspects 17-22 capable of forming an emulsion in a mixture of equal parts water and oil.

24. The oil seed protein isolate of any of Aspects 17-23, wherein the oil seed is canola.

25. The oil seed protein isolate of Aspect 24 comprising oleosin.

26. The oil seed protein isolate of any of Aspects 24-25, wherein the protein component comprises 5-20% oleosin.

27. The oil seed protein isolate of any of Aspects 24-26, wherein the protein component comprises 12-15% oleosin.

28. The oil seed protein isolate of any of Aspects 24-27, wherein the protein content comprises:
a. 50-65% cruciferin,
b. 10-20% oleosin, and
c. 8-15% napin.

29. The oil seed protein isolate of any of Aspects 24-28 capable of gelling at a protein concentration of ≥0.5%.

30. The oil seed protein isolate of any of Aspects 24-29 capable of gelling at a protein concentration of 0.5-5%.

31. The oil seed protein isolate of any of Aspects 24-30 having a foaming capacity of ≥100% a concentration of 0.5-5% by weight.

32. The oil seed protein isolate of any of Aspects 24-31 having a foaming capacity of 180-300% at a concentration of 5% by weight.

33. The oil seed protein isolate of any of Aspects 24-32 having foaming stability of 50-95% for ≥100 minutes at a concentration of 0.5-5% by weight.

34 The canola seed protein isolate of any of Aspects 24-33 having foaming stability of 50-95% for at least 200 minutes at a concentration of 5% by weight.

35. The oil seed protein isolate of any of Aspects 24-34 having emulsion stability of 100% for at least 24 hours at ≥0.5% concentration in a mixture of equal parts oil and water.

36. The oil seed protein isolate of any of Aspects 24-35 having oil/water emulsion stability of 100% for at least 48 hours at ≥0.5% protein concentration.

37. The oil seed protein isolate of any of Aspects 24-36 having oil/water emulsion stability of 100% for at least 48 hours at 0.5-5% protein concentration.

38. The oil seed protein isolate of any of Aspects 17-23, wherein the oil seed is sunflower seed.

39. The oil seed protein isolate of Aspect 38 comprising a protein component that is 80 wt % (N×6.25) to 93 wt % on a dry basis.

40. The oil seed protein isolate of any of Aspects 38-39, wherein its protein component comprises 50-90% helianthin proteins and 10-40% albumin and oleosin proteins.

41. The oil seed protein isolate of any of Aspects 38-40 capable of gelling in water at a concentration of 5%.

42. The oil seed protein isolate of any of Aspects 38-41 having a foaming capacity of 180-300% in water at a concentration of 5% by weight.

43. The oil seed protein isolate of any of Aspects 38-42 having a foaming stability of 50-80% in water at a concentration of 5% by weight for a period of ≥60 minutes.

44. The oil seed protein isolate of any of Aspects 38-43 having emulsion stability in aa mixture of equal part oil and water of 100% for ≥24 hours a concentration of 0.5-5% by weight.

45. A canola seed protein isolate comprising oleosin.

46 The canola seed protein isolate of Aspect 45, wherein the protein component comprises 10-20% oleosin.

47. The canola seed protein isolate of any of Aspects 45-46, wherein the protein content comprises:
a. 50-65% cruciferin,
b. 10-20% oleosin, and
c. 8-15% napin.

48. The canola seed protein isolate of Aspect 47, further comprising:
d. 1-3% fat,
e. ≥1.5% phytates,
f. 5-8% carbohydrates,
g. 4-6% ash,
h. ≤0.5% polyphenol,
i. ≤0.1% glucosinolates.

49. The canola seed protein isolate of any of Aspects 45-48, capable of gelling at a concentration of ≥3% in water.

50. The canola seed protein isolate of any of Aspects 45-49 capable of gelling at a concentration of 3-5%.

51. The canola seed protein isolate of any of Aspects 45-50 having a foam expansion capacity of ≥100% at a concentration of 0.5-5% by weight.

52. The canola seed protein isolate of any of Aspects 45-51 having a foam expansion capacity of 180-300% at a concentration of 5% by weight.

53. The canola seed protein isolate of any of Aspects 45-52 having foaming stability of 50-95% for ≥100 minutes.

54. The canola seed protein isolate of any of Aspects 45-53 having foaming stability of 50-95% for at least 200 minutes.

55. The canola seed protein isolate of any of Aspects 45-54 having oil/water emulsion stability of 100% for at least 24 hours at ≥0.5% protein concentration.

56. The canola seed protein isolate of any of Aspects 45-55 having oil/water (50/50) emulsion stability of 100% for at least 48 hours at a concentration of ≥0.5% by weight.

57. The canola seed protein isolate of any of Aspects 45-56 having oil/water emulsion stability of 100% for at least 48 hours at a concentration of 0.5-5% by weight.

58. The canola seed protein isolate of any of Aspects 45-57, wherein the protein is substantially in its native form.

59. Use of the oil seed protein isolate of any of Aspects 17-58 in the production of a foam.

60. Use of the oil seed protein isolate of any of Aspects 17-58 in the production of a gel.

61. Use of the oil seed protein isolate of any of Aspects 17-58 in the production of an emulsion.

62. The use of Aspect 61, wherein the emulsion is made from a mixture of equal parts oil and water.

63. A foam comprising the oil seed protein isolate of any of Aspects 17-58.

64. The foam of Aspect 63, wherein the foam comprises a concentration of ≥5% by weight of said oil seed protein isolate.

65. The foam of Aspect 63, wherein the foam comprises a concentration of ≥0.5% by weight of said oil seed protein isolate.

66. The foam of Aspect 63, wherein the foam comprises a concentration of 0.5-5% by weight of said oil seed protein isolate.

67. A gel comprising the canola seed protein isolate of any of Aspects 17-58.

68. The gel of Aspect 67, wherein the gel comprises a concentration of 3% of said oil seed protein isolate.

69. The gel of Aspect 67, wherein the gel comprises a concentration of ≥3% of said oil seed protein isolate.

70. The gel of Aspect 67, wherein the gel comprises a concentration of 3-5% of said oil seed protein isolate.

71. An emulsion comprising the oil seed protein isolate of any of Aspects 17-58.

72. The emulsion of Aspect 71 wherein the emulsion comprises a concentration of 0.5% of said oil seed protein isolate.

73. The emulsion of Aspect 71 wherein the emulsion comprises a concentration of ≥0.5% of said oil seed protein isolate.

74. The emulsion of Aspect 71 wherein the emulsion comprises a concentration of 0.5-5% of said oil seed protein isolate.

75. Use of the oil seed protein isolate of any of Aspects 17-58 in a food or beverage application.

76. The use of Aspect 75, wherein the food or beverage application is selected from milk shake, protein bars, meat analogues, confectionary, condiments, mayonnaise, salad dressing, nutritional supplements and diary alternatives.

77. The use of Aspect 76, wherein the dairy alternative is selected from creamers, ice cream, yogurt, buttermilk and cheese.

78. A food or beverage comprising the oil seed protein isolate of any of Aspects 17-58.

### EXAMPLES

The following examples are put forth so as to provide those of ordinary skill in the art with a complete disclosure and description of how to make and use the present invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1: Extraction of Canola Seed Protein Isolate from Canola Flour

### A.

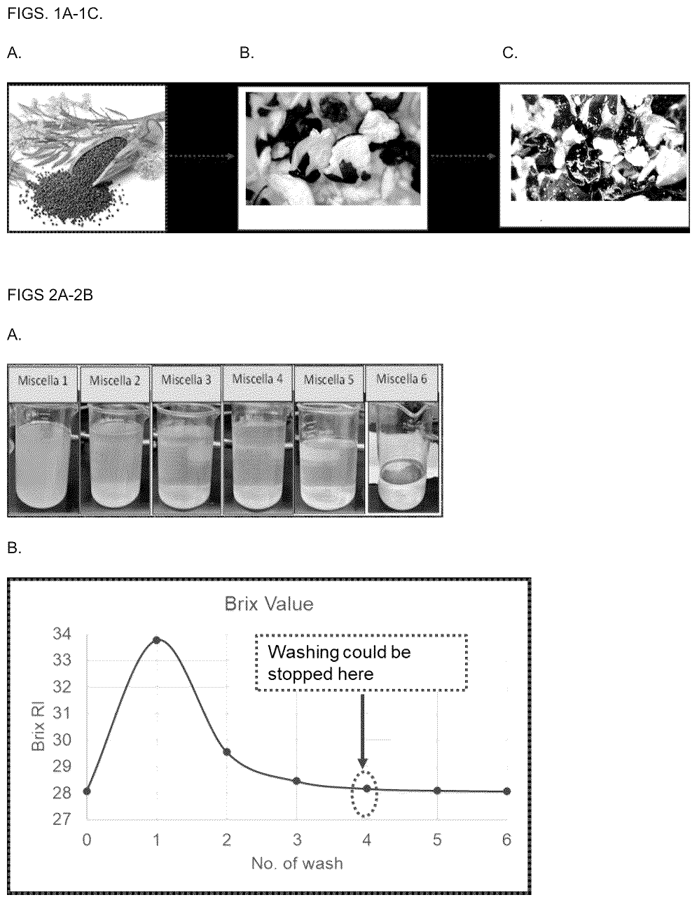

Canola oil seeds were flaked at a low temperature ≤50° C. FIGS. 1A-1C pictures canola seeds, flaked canola seed flour and de-oiled flaked canola seed flour in Figures A, B and C, respectively.

Oil was extracted from the flaked canola seeds using a Nutsche Filter (NF). The flaked canola seed flour was mixed with hexane at a ratio of 1:3 (w:v) and 6 cycles of extraction were performed at a maintained temperature of 50° C.; each extraction lasted 5-45 minutes. FIG. 2A shows the hexane with extracted oil after each of 6 rounds of extraction.

FIG. 2B shows the Brix refractive index (Brix RI) for hexane (at point 0) and for each of the 6 extraction cycles. Based on the refractive index returning essentially to baseline after cycle 4, it was determined that oil separation ≥99% could be obtained in a minimum of 4 cycles.

### B.

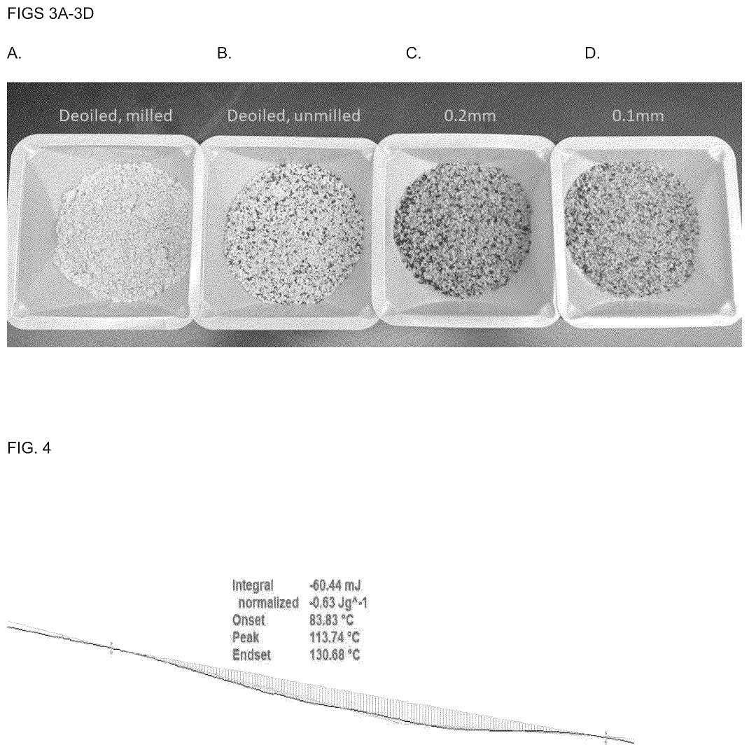

Canola oil seeds were dehulled and/or flaked at a thickness 0.1 mm or 0.2 mm and aspirated at a low temperature (≤50° C.). Oil was extracted from the flaked canola seeds using a Nutsche Filter (NF). The flaked canola seed flour was mixed with hexane in a ratio of 1:1 to 1:3 (w:v) and 4 cycles of extraction were performed at a maintained temperature of 50° C.; each extraction lasted 15 minutes. FIGS. 3A-3D show canola four after de-oiling and milling, after de-oiling before milling, flaked at 0.2 mm before de-oiling and flaked at 0.1 mm before de-oiling, respectively.

Table 1 shows protein content of the flaked canola seed before and after oil removal. Based on the refractive index (starting BRIX RI 35.6 to 26.1), it was determined that oil separation ≥99% could be obtained in a minimum of 3 cycles. Differential scanning calorimetry (DSC) was performed on the deoiled canola seed flakes. FIG. 4 shows one such DSC plot, indicating that the protein is native in the de-oiled flakes.

TABLE 1

| Sample | Protein (%) |
|---|---|
| Flakes 0.1 mm | 23.5 |
| Flakes 0.2 mm | 23.1 |
| Deoiled Flakes 0.1 mm | 44.0 |
| Deoiled Flakes 0.1 mm | 43.8 |

### Example 2: Extraction of Canola Protein Isolate (CPI)

### A.

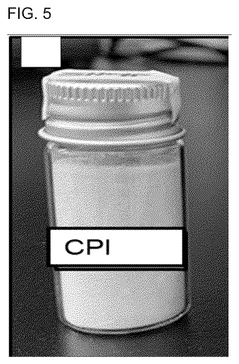

De-oiled, desolvented canola seed flour was dehulled by sieving via a 300-450 μm screen. The resulting flour was placed in an aqueous solution at pH 7.5 and a temperature of 55° C. to a concentration of 10% solids. After 30 minutes extraction time, the mixture was centrifuged for 10 minutes at 5000 g at room temperature to separate the solid and liquid fractions. The extracted, separated flour was washed 2× with additional alkaline hydration solution and the liquid collected and added to the first liquid fraction. The protein in the separated liquid fraction was precipitated out over 60 minutes by reducing the pH of the liquid to pH 7, then reducing the pH further to pH 4, maintaining a temperature of 4° C. The protein was separated from the remaining liquid by decantation, washed 2× with water at pH 4. The washed and separated protein was then diluted with water, adjusted to pH 7, to form a slurry. The slurry was homogenized using a high pressure homogenizer, then sterilized using direct steam injection for 2 seconds-10 minutes, the steam at 75-140° C. The protein slurry was dried using a freeze spray drier to produce the resulting CPI. Exemplary CPI is shown in FIG. 5.

### B.

De-oiled, desolvented canola seed flour was dehulled by sieving via a 300-450 μm screen. The resulting flour was placed in an aqueous solution containing 0.2% sodium hexametaphosphate (SHMP) at pH 9 and a temperature of 55° C. to a concentration of 10% solids. After 30 minutes extraction time, the mixture was centrifuged for 10 minutes at 5000 g at room temperature to separate the solid and liquid fractions. The extracted, separated flour was washed 2× with additional alkaline hydration solution and the liquid collected and added to the first liquid fraction. The protein in the separated liquid fraction was precipitated out over 60 minutes by reducing the pH of the liquid to pH 7, then reducing the pH further to pH 4, maintaining a temperature of 4° C. The protein was separated from the remaining liquid by decantation, washed 2× with water at pH 4. The washed and separated protein was then diluted with water, adjusted to pH 7, to form a slurry. The slurry was homogenized using a high pressure homogenizer, then sterilized using direct steam injection for 2 seconds-10 minutes, the steam at 75-140° C. The protein slurry was dried using a freeze spray drier to produce the resulting CPI.

### C.

De-oiled, desolvented canola seed flour was dehulled by sieving via a 300-450 μm screen. The resulting flour was placed in an aqueous solution at pH 10 and a temperature of 55° C. to a concentration of 10% solids. After 30 minutes extraction time, the mixture was centrifuged for 10 minutes at 5000 g at room temperature to separate the solid and liquid fractions. The extracted, separated flour was washed 2× with additional alkaline hydration solution and the liquid collected and added to the first liquid fraction. The protein in the separated liquid fraction was precipitated out over 60 minutes by reducing the pH of the liquid to pH 7, then reducing the pH further to pH 4.5, maintaining a temperature of 4° C. The protein was separated from the remaining liquid by decantation, washed 2× with water at pH 4. The washed and separated protein was then diluted with water, adjusted to pH 7, to form a slurry. The slurry was homogenized using a high pressure homogenizer, then sterilized using direct steam injection for 2 seconds-10 minutes, the steam at 75-140° C. The protein slurry was dried using a freeze spray drier to produce the resulting CPI.

### D.

De-oiled, desolvented flaked and aspirated canola seed was placed in an aqueous solution or an aqueous solution containing 0.5% SHMP at pH 7.5 and a temperature of 55° C. to a concentration of 10-20% solids. After 30 minutes extraction time, the mixture was centrifuged for 10 minutes at 5000 g at room temperature. The extracted, separated flour was washed 2× with additional alkaline hydration solution and the liquid collected and added to the first liquid fraction. The protein in the separated liquid fraction was precipitated out over 60 minutes by reducing the pH of the liquid to pH 4 at a temperature of 55° C. The protein was separated from the remaining liquid by decantation, washed 2× with water at pH 4-5. The washed and separated protein was then diluted with water, adjusted to pH 7, to form a slurry. The slurry was homogenized using a high-pressure homogenizer, then sterilized using direct steam injection for 2 seconds-10 minutes, the steam at 75-140° C. The protein slurry was dried using a freeze spray drier to produce the resulting CPI.

Table 2 provides several characteristics of the resulting CPI. Solubility was determined in water, pH 7. Oil holding capacity (OHC) and water holding capacity (WHC) were determined by mixing 1 g of canola flour with 10 mL of oil or water in a centrifuge tube, vortexed and kept at room temperature for 1 h. The suspension was then centrifuged at 20 g for 30 min and the volume of oil or water in the sediment was measured. OHC and WHO were calculated as g of oil or water absorbed per gram of canola flour. Protein content is presented as wt % on a dry basis. Moisture content is also presented.

TABLE 2

| Properties | CPI |
|---|---|
| Solubility (%) | 22 |
| OHC (g/g) | 4.3 |
| WHC (g/g) | 5.4 |
| Protein | 85% |
| Moisture | 5% |

### Example 3: Maintained Integrity of Native Protein Form in Canola Protein Isolate

Differential scanning calorimetry was performed on the resulting CPI (FIG. 6), showing a thermal transition profile with exothermal events occurring at about 77 and 109° C., corresponding to denaturation of cruciferin and napin, respectively. This confirms that the protein in the CPI is substantially in its native form.

### Example 4: Protein Composition of CPI

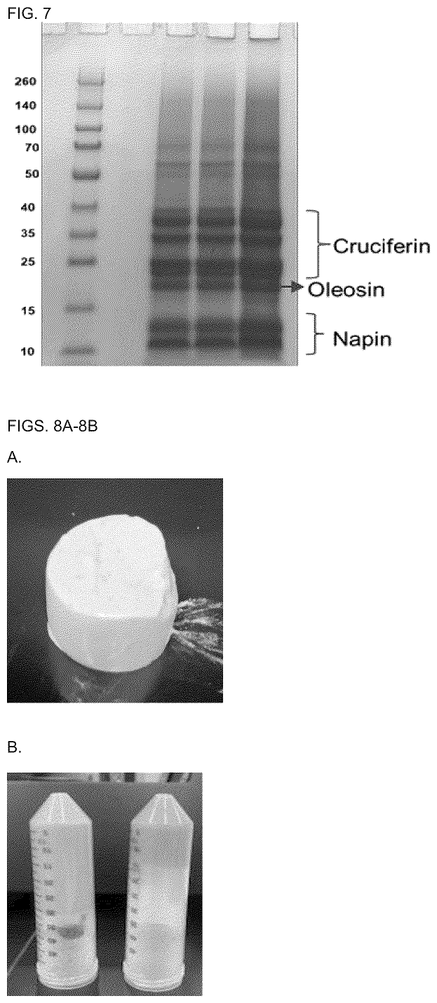

CPI produced using the extraction process taught herein was analyzed by SDS-PAGE, which separated proteins in a sample by their molecular weight. FIG. 7 shows and SDS-PAGE analysis of CPI, showing the presence of cruciferin, oleosin and napin. For the protein fraction of the CPI sample, cruciferin made up 50-65%, oleosin made up 12-15% and napin made up 8-20%.

### Example 5: Gelling Capacity of CPI

Least gelation concentration (LGC) was determined for one batch of CPI produced as described herein. LGC was determined using various concentrations of CPI in water. The mixture was heated to 95° C., then cooled to 5° C. The LGC for this batch was determined to be 3-5%. Samples of gels produced are shown in FIG. 8A-8B.

### Example 6: Foaming Capacity of CPI

Foams were made with 20 ml of a 5% CPI solution in water. Foams were made using an homogenizer at 10000 rpm for 5 minutes. Foaming expansion capacity (% FE) was calculated using the equation % FE=Vfo/Vli×100, where Vfo is foam volume and Vli is the volume of the liquid before foaming. The CPI displayed a foaming expansion capacity of 180-300%.

Foaming stability (% FS) was determined using the equation % FS=[(Vli-VIt)/(Vli-Vlo)], where VIt is the liquid volume after 200 minutes, and Vlo is the volume of liquid immediately after foaming. The CPI displayed a foaming stability of 50-95% after 200 minutes.

### Example 7: Emulsion Capacity of CPI

Emulsions using varied concentrations of CPI (0.5-5%) in a mixture of equal parts oil and water were made using a homogenizer at 8000 rpm for 3 minutes. The emulsions displayed 100% stability after 5 days cold storage.

### Example 8: Extraction of Sunflower Protein Isolate from Sunflower Seed Flour

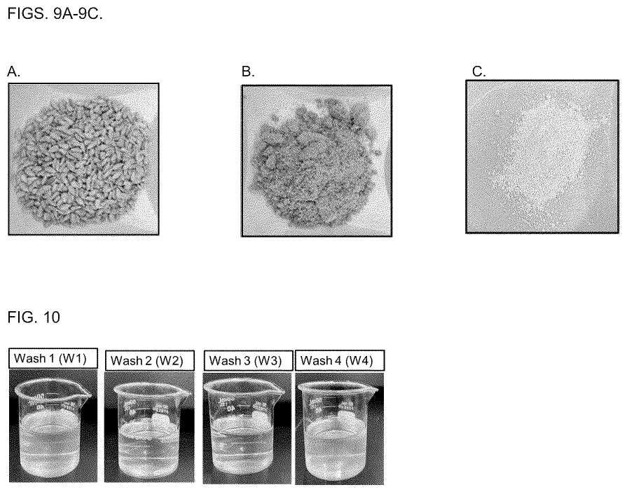

Sunflower seeds were ground in a mill at room temperature to form a sunflower seed flour. The sunflower seed flower was extracted with hexane at a flour to hexane ratio of about 1:2 (w:v) in a Nutsche Filter at an extraction temperature of about 50° C. and an extraction time of 15 minutes. FIGS. 9A, B and C show sunflower seeds, ground sunflower seed flour and de-oiled sunflower seed flour, respectively. The extraction cycle was repeated 4 times. FIG. 10 shows the hexane with extracted oil after each of 4 rounds of extraction. Table 3 shows the dry matter (DM) content and Brix refractive index of the hexane and oil after four sequential extraction cycles, showing that ≥99% oil extraction was complete after 3-4 cycles.

TABLE 3

| Wash | Hx (mL) | DM (%) | Brix RI |
|---|---|---|---|
| W0 | 0 | — | 26.1 |
| W1 | 400 | 25.5 | 37.6 |
| W2 | 400 | 8.8 | 29.9 |
| W3 | 400 | 0.6 | 27.1 |
| W4 | 400 | 0.2 | 26.2 |

Sunflower seed flour was desolventized at 55° C. for 30 minutes. The de-oiled sunflower seed flour obtained had ≤1% oil, about 54% protein (dry basis) and 60-100 ppm hexane.

### Example 9: Extraction of Sunflower Seed Protein Isolate (SFPI)

### A.

A fine fraction of de-oiled, desolvented sunflower seed flour was obtained by sieving via a 300-450 μm screen. The resulting flour was placed in an aqueous solution at pH 7.5 and a temperature of 55° C. to a concentration of 10% solids. After 30 minutes extraction time, the mixture was centrifuged for 10 minutes at 5000 g at room temperature to separate the solid and liquid fractions. The extracted, separated flour was washed 2× with additional alkaline hydration solution and the liquid collected and added to the first liquid fraction. The protein in the separated liquid fraction was precipitated out over 60 minutes by reducing the pH of the liquid to pH 7, then reducing the pH further to pH 4, maintaining a temperature of 4° C. The protein was separated from the remaining liquid by decantation, washed 2× with water at pH 4. The washed and separated protein was then diluted with water, adjusted to pH 7, to form a slurry. The slurry was homogenized using a high pressure homogenizer, then sterilized using direct steam injection for 2 seconds-10 minutes, the steam at 75-140° C. The protein slurry was dried using a freeze spray drier to produce the resulting SFPI.

### B.

A fine fraction of de-oiled, desolvented sunflower seed flour was obtained by sieving via a 300-450 μm screen. The resulting flour was placed in an aqueous solution containing 0.5% sodium hexametaphosphate at pH 7.5 and a temperature of 55° C. to a concentration of 10% solids. After 30 minutes extraction time, the mixture was centrifuged for 10 minutes at 5000 g at room temperature to separate the solid and liquid fractions. The extracted, separated flour was washed 2× with additional alkaline hydration solution and the liquid collected and added to the first liquid fraction. The protein in the separated liquid fraction was precipitated out over 60 minutes by reducing the pH of the liquid to pH 7, then reducing the pH further to pH 4, maintaining a temperature of 4° C. The protein was separated from the remaining liquid by decantation, washed 2× with water at pH 4. The washed and separated protein was then diluted with water, adjusted to pH 7, to form a slurry. The slurry was homogenized using a high pressure homogenizer, then sterilized using direct steam injection for 2 seconds-10 minutes, the steam at 75-140° C. The protein slurry was dried using a freeze spray drier to produce the resulting SFPI.

### Example 10: Maintained Integrity of Native Protein Form in SFPI

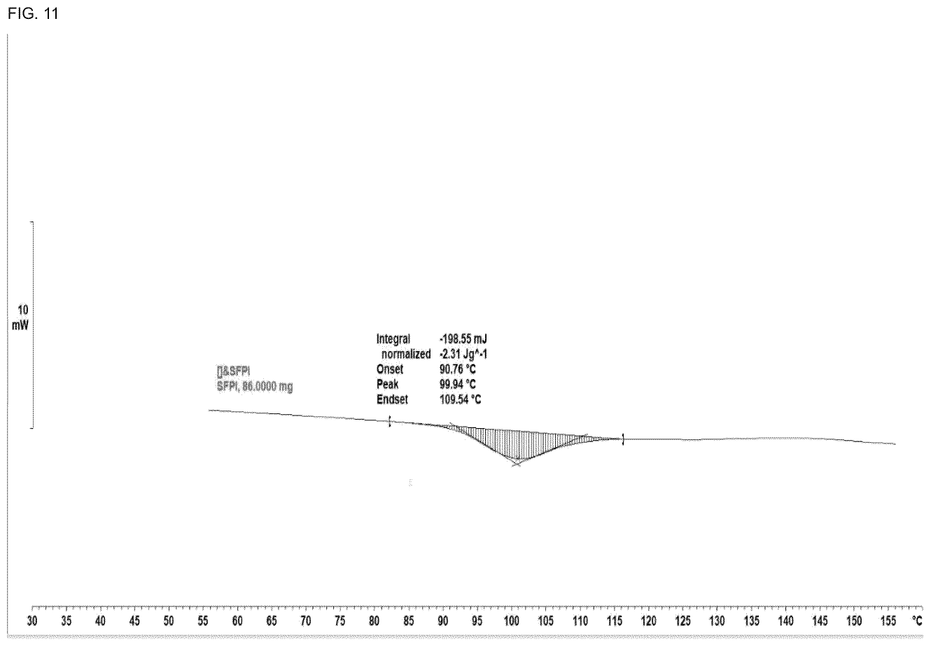

Differential scanning calorimetry was performed on the resulting SFPI (FIG. 11), showing a thermal transition profile with an exothermal event having onset at about 90.8° C., a peak at about 90.9° C. and endset at about 109.5° C., corresponding to denaturation of protein in the isolate. This confirms that the protein in the SFPIPI is substantially in its native form.

### Example 11: Gelling Capacity of SFPI

Least gelation concentration (LGC) was determined for one batch of SFPI produced as described herein. LGC was determined using various concentrations of SFPI in water. The mixture was heated to 95° C., then cooled to 5° C. The LGC for this batch was determined to be 5%.

### Example 12: Foaming Capacity of SFPI

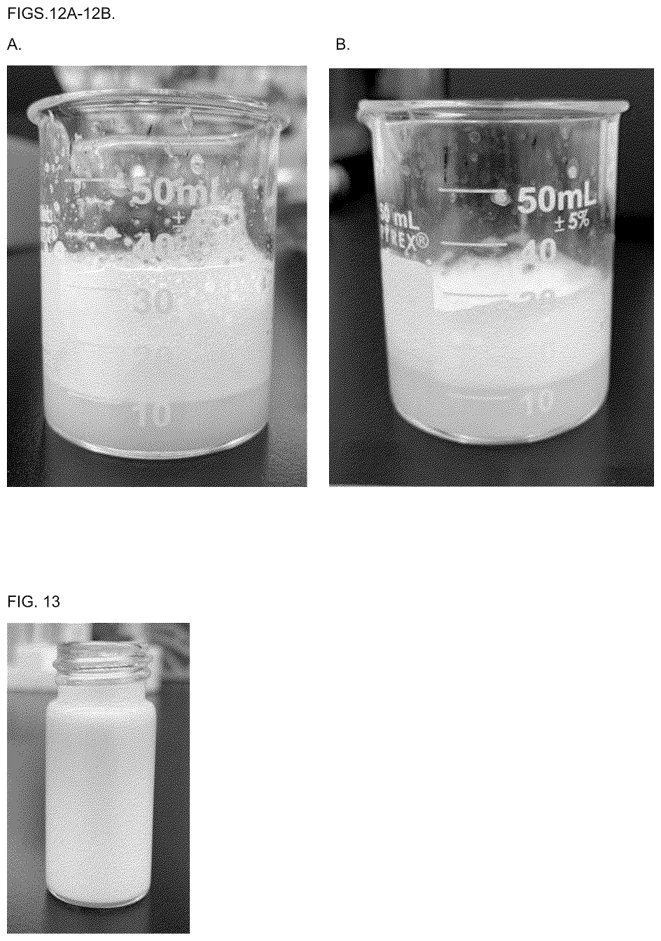

Foams were made with 20 ml of a 5% SFPI solution in water. Foams were made using an homogenizer at 10000 rpm for 5 minutes. Foaming expansion capacity (% FE) was calculated using the equation % FE=Vfo/Vli×100, where Vfo is foam volume and Vli is the volume of the liquid before foaming. The SFPI displayed a foaming expansion capacity of 180-300%. FIG. 12A shows an example of the foam expansion immediately after foaming.

Foaming stability (% FS) was determined using the equation % FS=[(Vli-VIt)/(Vli-Vlo)], where VIt is the liquid volume after a measured period, and Vlo is the volume of liquid immediately after foaming. The CPI displayed a foaming stability of 50-80% after 60-200 minutes. FIG. 12B shows an example of 5% SFPI foam after 60 minutes.

### Example 13: Emulsion Capacity of SFPI

Emulsions using varied concentrations of SFPI (0.5-5%) in a mixture of equal parts oil and water were made using a homogenizer at 8000 rpm for 3 minutes. The emulsions had a mayonnaise-like texture and displayed 100% stability after 24 hours cold storage. FIG. 13 shows an example of an emulsion produced from the SFPI prepared at pH 7.

What is claimed is:

1. An oil seed protein isolate extraction process comprising, step-wise:
a. separating hulls, if present, from desolvented, de-oiled oil seed flour,
b. alkaline hydration of hull-free, desolvented, de-oiled oil seed flour with an aqueous solution:
i) at a pH of 7-11,
ii) at a temperature of 5-62° C.,
iii) optionally including Na and/or Ca and/or Mg salt,
c. separation of solids from the solution, producing a liquid fraction,
d. precipitation and separation of protein from liquid fraction:
i) at pH 3-7.5
ii) at a temperature of 5-62° C.,
e. dilution of the protein to produce a slurry,
f. homogenization and sterilization of protein slurry, and
g. drying protein slurry.

2. The process of claim 1, wherein the de-oiled, desolvented oil seed flour contains ≤3% oil.

3. The process of any of claims 1-2, wherein the pH in step a. is 7.5-10.

4. The process of any of claims 1-3, wherein the temperature in step b. is 18-60° C.

5. The process of any of claims 1-4, wherein each salt is independently selected from NaCl, CaCl, MgCl, Sodium hexametaphosphate, calcium perchlorate, sodium sulfite, sodium bisulfite, sodium thiocyanate and calcium thiocyanate.

6. The process of any of claims 1-5, wherein the salt concentration in step b. is 0.1-5%.

7. The process of any of claims 1-6, wherein the solids concentration in step b. is 10-20%.

8. The process of any of claims 1-7, wherein the alkaline hydration step b. is carried out for 30-60 minutes.

9. The process of any of claims 1-8, wherein separation step c. is by decantation and/or centrifugation.

10. The process of any of claims 1-9, wherein precipitation of step d. is performed at pH 4-7.

11. The process of any of claims 1-10, wherein precipitation of step d. is performed at pH 4-6.

12. The process of any of claims 1-11, wherein the temperature in step d. is 18-60° C.

13. The process of any of claims 1-12, wherein the dilution step is with water and adjusted to about pH 7.

14. The process of any of claims 1-13, wherein the oil seed is selected from the group comprising: rapeseed (including canola), sunflower seed, mustard seed, cotton seed, peanut, sesame, safflower, soybean, flax seed, tree nuts, palm kernel and corn.

15. The process of any of claims 1-14, wherein the oil seed is canola.

16. The process of any of claims 1-14, wherein the oil seed is sunflower.

17. An oil seed protein isolate made by the process of any of claims 1-16.

18. The oil seed protein isolate of claim 17, wherein the protein content is 80-98 wt % (N×6.25) d.b.

19. The oil seed protein isolate of any of claims 17-18, wherein the protein is substantially maintained in its native form.

20. The oil seed protein isolate of any of claims 17-19, wherein the oil seed is selected from the group comprising: rapeseed (including canola), sunflower seed, mustard seed, cotton seed, peanut, sesame, safflower, soybean, flax seed, tree nuts, palm kernel and corn.

21. The oil seed protein isolate of any of claims 17-20 capable of forming a gel in water.

22. The oil seed protein isolate of any of claims 17-21 having foaming capacity in water.

23. The oil seed protein isolate of any of claims 17-22 capable of forming an emulsion in a mixture of equal parts water and oil.

24. The oil seed protein isolate of any of claims 17-23, wherein the oil seed is canola.

25. The oil seed protein isolate of claim 24 comprising oleosin.

26. The oil seed protein isolate of any of claims 24-25, wherein the protein component comprises 5-20% oleosin.

27. The oil seed protein isolate of any of claims 24-26, wherein the protein component comprises 12-15% oleosin.

28. The oil seed protein isolate of any of claims 24-27, wherein the protein content comprises:
a. 50-65% cruciferin,
b. 10-20% oleosin, and
c. 8-15% napin.

29. The oil seed protein isolate of any of claims 24-28 capable of gelling at a protein concentration of ≥0.5%.

30. The oil seed protein isolate of any of claims 24-29 capable of gelling at a protein concentration of 0.5-5%.

31. The oil seed protein isolate of any of claims 24-30 having a foaming capacity of ≥100% a concentration of 0.5-5% by weight.

32. The oil seed protein isolate of any of claims 24-31 having a foaming capacity of 180-300% at a concentration of 5% by weight.

33. The oil seed protein isolate of any of claims 24-32 having foaming stability of 50-95% for ≥100 minutes at a concentration of 0.5-5% by weight.

34. The canola seed protein isolate of any of claims 24-33 having foaming stability of 50-95% for at least 200 minutes at a concentration of 5% by weight.

35. The oil seed protein isolate of any of claims 24-34 having emulsion stability of 100% for at least 24 hours at ≥0.5% concentration in a mixture of equal parts oil and water.

36. The oil seed protein isolate of any of claims 24-35 having oil/water emulsion stability of 100% for at least 48 hours at ≥0.5% protein concentration.

37. The oil seed protein isolate of any of claims 24-36 having oil/water emulsion stability of 100% for at least 48 hours at 0.5-5% protein concentration.

38. The oil seed protein isolate of any of claims 17-23, wherein the oil seed is sunflower seed.

39. The oil seed protein isolate of claim 38 comprising a protein component that is 80 wt % (N×6.25) to 93 wt % on a dry basis.

40. The oil seed protein isolate of any of claims 38-39, wherein its protein component comprises 50-90% helianthin proteins and 10-40% albumin and oleosin proteins.

41. The oil seed protein isolate of any of claims 38-40 capable of gelling in water at a concentration of 5%.

42. The oil seed protein isolate of any of claims 38-41 having a foaming capacity of 180-300% in water at a concentration of 5% by weight.

43. The oil seed protein isolate of any of claims 38-42 having a foaming stability of 50-80% in water at a concentration of 5% by weight for a period of ≥60 minutes.

44. The oil seed protein isolate of any of claims 38-43 having emulsion stability in aa mixture of equal part oil and water of 100% for ≥24 hours a concentration of 0.5-5% by weight.

45. A canola seed protein isolate comprising oleosin.

46. The canola seed protein isolate of claim 45, wherein the protein component comprises 10-20% oleosin.

47. The canola seed protein isolate of any of claims 45-46, wherein the protein content comprises:
a. 50-65% cruciferin,
b. 10-20% oleosin, and
C. 8-15% napin.

48. The canola seed protein isolate of claim 47, further comprising:
d. 1-3% fat,
e. ≥1.5% phytates,
f. 5-8% carbohydrates,
g. 4-6% ash,
h. ≤0.5% polyphenol, and
i. ≤0.1% glucosinolates.

49. The canola seed protein isolate of any of claims 45-48, capable of gelling at a concentration of ≥3% in water.

50. The canola seed protein isolate of any of claims 45-49 capable of gelling at a concentration of 3-5%.

51. The canola seed protein isolate of any of claims 45-50 having a foam expansion capacity of ≥100% at a concentration of 0.5-5% by weight.

52. The canola seed protein isolate of any of claims 45-51 having a foam expansion capacity of 180-300% at a concentration of 5% by weight.

53. The canola seed protein isolate of any of claims 45-52 having foaming stability of 50-95% for ≥100 minutes.

54. The canola seed protein isolate of any of claims 45-53 having foaming stability of 50-95% for at least 200 minutes.

55. The canola seed protein isolate of any of claims 45-54 having oil/water emulsion stability of 100% for at least 24 hours at ≥0.5% protein concentration.

56. The canola seed protein isolate of any of claims 45-55 having oil/water (50/50) emulsion stability of 100% for at least 48 hours at a concentration of ≥0.5% by weight.

57. The canola seed protein isolate of any of claims 45-56 having oil/water emulsion stability of 100% for at least 48 hours at a concentration of 0.5-5% by weight.

58. The canola seed protein isolate of any of claims 45-57, wherein the protein is substantially in its native form.

59. Use of the oil seed protein isolate of any of claims 17-58 in the production of a foam.

60. Use of the oil seed protein isolate of any of claims 17-58 in the production of a gel.

61. Use of the oil seed protein isolate of any of claims 17-58 in the production of an emulsion.

62. The use of claim 61, wherein the emulsion is made from a mixture of equal parts oil and water.

63. A foam comprising the oil seed protein isolate of any of claims 17-58.

64. The foam of claim 63, wherein the foam comprises a concentration of ≥5% by weight of said oil seed protein isolate.

65. The foam of claim 63, wherein the foam comprises a concentration of ≥0.5% by weight of said oil seed protein isolate.

66. The foam of claim 63, wherein the foam comprises a concentration of 0.5-5% by weight of said oil seed protein isolate.

67. A gel comprising the canola seed protein isolate of any of claims 17-58.

68. The gel of claim 67, wherein the gel comprises a concentration of 3% of said oil seed protein isolate.

69. The gel of claim 67, wherein the gel comprises a concentration of ≥3% of said oil seed protein isolate.

70. The gel of claim 67, wherein the gel comprises a concentration of 3-5% of said oil seed protein isolate.

71. An emulsion comprising the oil seed protein isolate of any of claims 17-58.

72. An emulsion of claim 71 wherein the emulsion comprises a concentration of 0.5% of said oil seed protein isolate.

73. The emulsion of claim 71 wherein the emulsion comprises a concentration of ≥0.5% of said oil seed protein isolate.

74. The emulsion of claim 71 wherein the emulsion comprises a concentration of 0.5-5% of said oil seed protein isolate.

75. Use of the oil seed protein isolate of any of claims 17-58 in a food or beverage application.

76. The use of claim 75, wherein the food or beverage application is selected from milk shake, protein bars, meat analogues, confectionary, condiments, mayonnaise, salad dressing, nutritional supplements and diary alternatives.

77. The use of claim 76, wherein the dairy alternative is selected from creamers, ice cream, yogurt, buttermilk and cheese.

78. A food or beverage comprising the oil seed protein isolate of any of claims 17-58.
